(19) United States
(12) Patent Application Publication
(10) Pub. No.: US 2004/0216562 A1
(43) Pub. Date: Nov. 4, 2004

(54) Bulb replacement tool

(76) Inventor: Daniel T. Ireland, Cave Creek, AZ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/426,072

(22) Filed: Apr. 29, 2003

(51) Int. Cl. H01K 3/32

(52) U.S. Cl. 81/53.11

(57) ABSTRACT

A tool having first and second levers pivotably mounted in the manner of pliers with handle ends and opposite jaw ends. At the jaw ends the levers' jaws face one another and have complementary structures that can grasp a bulb therebetween. Each jaw has a shoulder at one lateral jaw side and a lip at the end of the lever. The lips of the facing jaws are adjacent one another, and the shoulder of one lever is on the opposite lateral side of the tool as the shoulder of the other lever. This creates a central jaw cavity on each jaw, and the facing cavities form a chamber in the jaw into which the bulb fits.

### (e) BACKGROUND OF THE INVENTION

1. Field of the Invention

This invention relates generally to hand tools, such as pliers, used to grasp objects, and more particularly to a hand tool used to grasp a lamp bulb for replacement.

2. Description of the Related Art

Conventional incandescent light bulbs are used in home lighting fixtures, and in industrial and commercial fixtures. Conventional incandescent light bulbs have a glass bulb in which a tungsten filament is housed. The filament degrades during use, and, upon failure of the filament, the bulb must be replaced. Changing such bulbs can be carried out by hand, usually by grasping the burned out bulb, unscrewing the bulb and replacing it with a new bulb by screwing the new bulb into the socket of the fixture. Other incandescent bulbs have different kinds of mounting structures, but most can be replaced by hand.

Halogen incandescent lights have become popular recently due to their efficiency, pleasing color and the fact that they are directional, meaning that they can be used as a spotlight. Halogen bulbs also fail after a limited time, albeit after a longer time than traditional incandescent bulbs, and-need to be replaced.

Some halogen bulbs have what are called “bayonet” style connectors, which include a pair of rigid metal conducting pins that extend from a base end of the bulb and are held by friction in a pair of corresponding terminals in the fixture. An electrical voltage is created between the terminals when the fixture is switched on. Such bulbs can be replaced by merely pulling them out, thereby overcoming the frictional engagement between the pins and the terminals of the light fixture.

Although such halogen bulbs can be removed by the strength and dexterity found in the average person's hand, such bulbs have a quartz (silica) bulb that is harmed by the oils that are present on human hands. If the oils come into contact with the bulb of a halogen light, small cracks will form that destroy the bulb, greatly decreasing the useful life of the new bulb.

The current ways of preventing oils from getting on small halogen bulbs during replacement include the use of gloves, and removal with bare fingers followed by cleaning of the new bulb after it has been placed in the fixture. Gloves are bulky and awkward, and the cleaning process requires the use of flammable and toxic materials. Furthermore, reaching the entire bulb with a cleaning instrument when the bulb is in the fixture is difficult and there is a risk that not all of the oil will be removed.

Therefore, the need exists for a means for effectively replacing halogen light bulbs without shortening the bulb's useful life.

### (f) BRIEF SUMMARY OF THE INVENTION

The invention is a bulb grasping tool. The tool includes a first elongated lever having a jaw end and an opposite handle end. A second elongated lever having a jaw end and an opposite handle end is pivotably mounted to the first lever at a pivot. The pivot is mounted to the second lever intermediate the jaw and handle ends and to the first lever intermediate the jaw and handle ends. This results in the levers operating like pliers on a clothespin.

The first lever has a first jaw at the jaw end of the first lever. The first jaw has a first shoulder near a first lateral edge of the first jaw. A first lip is transverse to the first shoulder and near the jaw end. A first central jaw cavity is defined by the first shoulder, the first lip, a first jaw floor and a second lateral edge of the first jaw opposite the first lateral edge.

The second lever has a second jaw at the jaw end of the second lever, and the second jaw faces the first jaw. The second jaw has a second shoulder near a first lateral edge of the second jaw. The second shoulder faces the second lateral edge of the first jaw. A second lip is transverse to the second shoulder and near the jaw end. The second lip faces the first lip. A second central jaw cavity is defined by the second shoulder, the second lip, a second jaw floor and a second lateral edge of the second jaw opposite the first lateral edge. The second central jaw cavity faces the first central jaw cavity forming, in an operable orientation, a chamber therebetween in which a bulb can be placed for grasping.

Thus, the pliers-like tool can accept a bulb in the chamber of the jaws, thereby permitting grasping of the bulb for removal and then grasping of a new bulb for insertion into the fixture. The tool securely grasps the bulb without getting any harmful oils onto the bulb, and is easily operated to remove an old bulb and install a new bulb.

### (g) BRIEF DESCRIPTION OF THE SEVERAL VIEWS OF THE DRAWINGS

FIG. 1 is a side view illustrating the preferred embodiment of the present invention.

FIG. 2 is a side view illustrating the jaw end of one lever.

FIG. 3 is a top view illustrating the jaw end of one lever.

FIG. 4 is a view in perspective illustrating one of the levers of the present invention.

FIG. 5 is a view in perspective illustrating a close-up of the pivot apparatus shown in FIG. 4.

FIG. 6 is an end view in section through the lines 6-6 of FIG. 1.

FIG. 7 is an end view in section through the lines 7-7 of FIG. 1.

FIG. 8 is an end view in section of an alternative embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

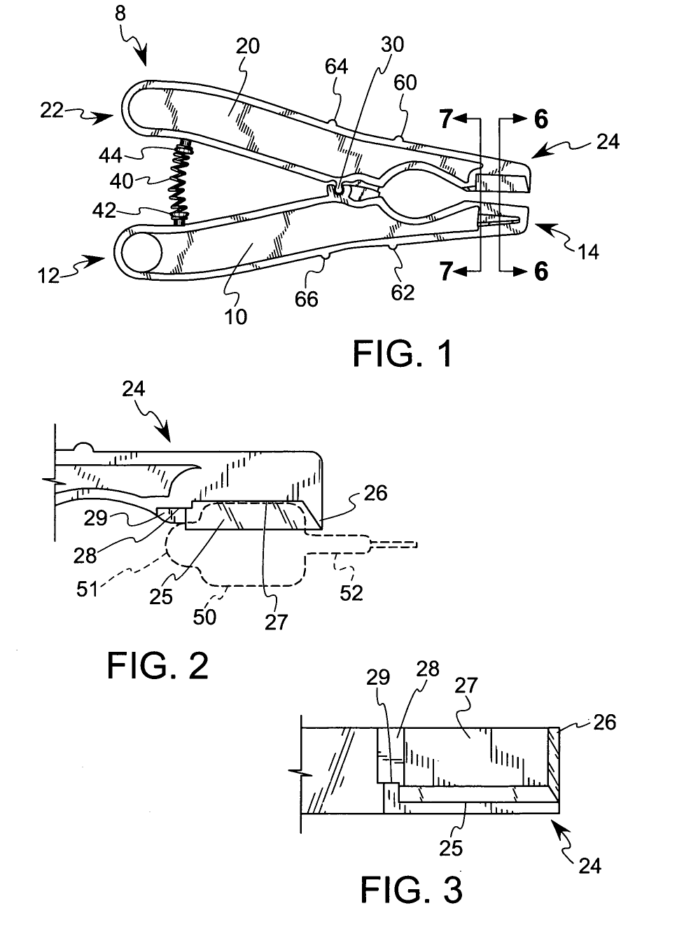

The preferred embodiment of the present invention is shown in FIG. 1, in which the tool 8 is made up of two levers 10 and 20. The first lever 10 is an elongated member having a handle end 12 and a jaw end 14. The second lever 20 is preferably an identical elongated member having a handle end 22 and a jaw end 24. The levers 10 and 20 are pivotably mounted together by a pivot member, preferably the hinge-pin apparatus 30, which is described in more detail below.

The hinge-pin apparatus 30 is mounted between the handle ends and the jaw ends of both levers 10 and 20, preferably closer to the jaw ends. Thus, the levers 10 and 20 are pivotably mounted to one another in the manner of pliers so that the handle ends 12 and 22 can be displaced toward one another and the jaw ends 14 and 24 can be displaced away from one another, and vice versa, by squeezing the handle ends of the levers.

In a preferred embodiment, the first and second studs 42 and 44 are mounted to the inwardly facing surfaces of the levers 10 and 12, respectively. A coil spring 40 is mounted at one end to the stud 42 and at the opposite end to the stud 44. The spring 40 exerts a gentle spreading force to the handle ends of the levers to spread the handle ends apart to their maximum opening, except when a greater force is applied to the levers to force the handle ends together.

The jaw end of each lever has a jaw which is the only part that contacts and grasps the bulb. The jaw end 24 is shown in a more magnified view in FIGS. 2 and 3. A shoulder 25 is formed near, and preferably at, a lateral edge of the jaw end 24. A lip 26 is transverse, and preferably perpendicular, to the shoulder 25. The jaw floor 27 extends from the base of the shoulder near one lateral edge of the jaw end 24 to the opposite lateral edge of the jaw end 24. The jaw floor 27, the shoulder 25 and the lip 26 define a central cavity in the jaw end 24, and a bulb that is grasped by the tool 8 fits in the cavity as described below. The jaw is made up of the structures that define the central jaw cavity.

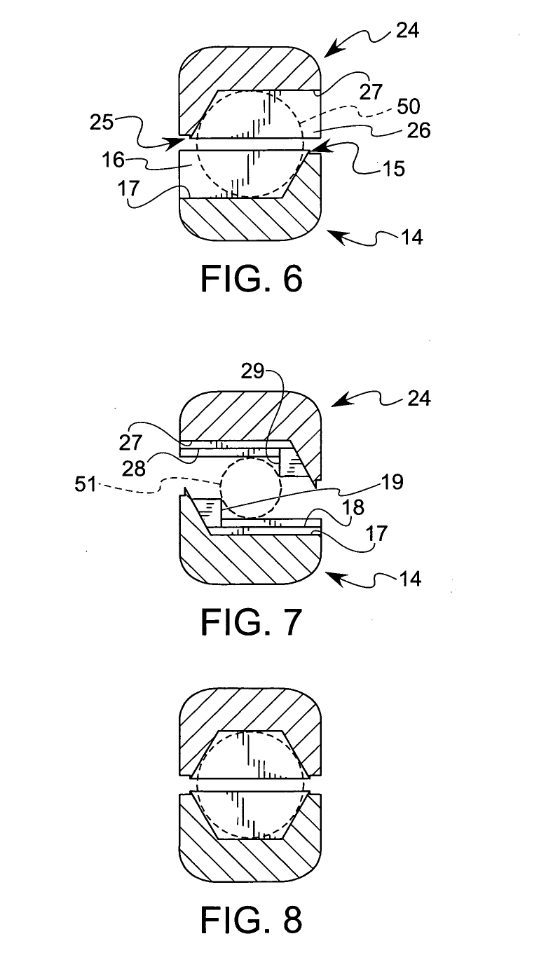

The jaw end 14 is substantially identical to the jaw end 24 as described above, and as shown in FIG. 6. Thus, a shoulder 15 is formed near, and preferably at, a lateral edge of the jaw end 14. A lip 16 is transverse, and preferably perpendicular, to the shoulder 15. A jaw floor 17 extends from the base of the shoulder 15 near one lateral edge of the jaw end 14 to the opposite lateral edge of the jaw end 14. The jaw floor 17, the shoulder 15 and the lip 16 define a central cavity in the jaw end 14, and the bulb that is grasped by the tool 8 fits in the cavity. The jaw of the jaw end 14 is also made up of the structures that define the central jaw cavity.

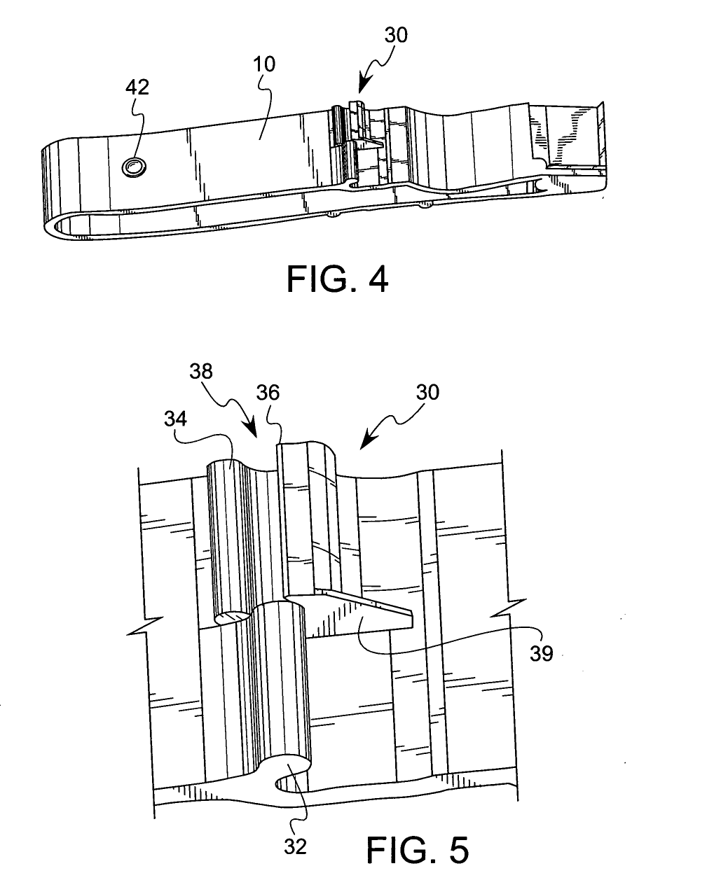

The hinge-pin apparatus 30 is illustrated in FIG. 4 in which the lever 10 is rotated from its position in FIG. 1 to show the inner surface to which the stud 42 and the hinge-pin apparatus 30 are mounted. In FIG. 5, which is a more magnified view of the hinge-pin apparatus 30, the hinge-pin apparatus 30 includes a pivot pin 32 and two lips 34 and 36 that form a pivot groove 38 therebetween. In the orientation of the levers 10 and 20 shown in FIG. 1, the pivot pin 32 is inserted into the pivot groove on the lever 20, and the pivot pin of the lever 20 is inserted into the pivot groove 38. Because the levers 10 and 20 are identical, when the levers 10 and 20 are positioned with their respective inner surfaces facing one another, the respective parts of the hinge-pin apparatus 30 mate together with the aligned pivot pins and pivot grooves forming a hinge that permits the relative pivoting motion described above. The side of the guide plate 39 seats against the side of a guide plate on the lever 20, and as the levers pivot relative to one another, the guide plates slide in a scissors action. The guide plates restrict lateral movement of one lever relative to the other, which could cause the levers to become misaligned.

The jaw ends 14 and 24 face each other when the tool 8 is in the operable position shown in FIG. 1 in which the levers 10 and 20 are pivotably mounted together. As shown in phantom in FIG. 2, the bulb 50 seats at its upper side against the floor of the jaw end 24, and seats at its underside against the floor of the jaw end 14. As shown in FIG. 6, the bulb 50 seats against the surfaces that define the central cavities of the jaw ends 14 and 24 including the surfaces extending from the shoulders 15 and 25 to the jaw floors 17 and 27, respectively. The bulb 50 is a typical 20 watt halogen bayonet-style bulb. In general, the tool 8 is designed to be particularly advantageous for use with halogen bulbs of 10 to 50 watts. However, the tool 8 works with a wide variety of bulbs outside of this range and configuration, and can be modified to work with other bulb styles and configurations as will become apparent to the skilled artisan.

As is also visible in FIG. 6, the shoulder 25 faces the lateral edge of the jaw end 14 that is laterally opposite the shoulder 15. Likewise, the shoulder 15 faces the lateral edge of the jaw end 24 that is laterally opposite the shoulder 25. This configuration of facing surfaces forms a chamber that limits the longitudinal and lateral movement of the bulb 50. For example, if a force is applied to the bulb that tends to move it to one side, it cannot pass between the shoulder on one of the jaws and the facing surface of the floor on the other jaw. Alternatively, if the bulb is forced to the other side, there is no space for it to pass between the shoulder of one jaw and the floor on the other jaw. The formation of a chamber is accomplished with only one shoulder on each jaw end. With this configuration, the bulb 50 is preferably contacted by the jaw surfaces on the top, bottom and sides of the bulb 50, and at the end of the bulb 50 by the lips 16 and 26. As shown in FIG. 8, it is possible to have shoulders on both sides of each jaw end to enhance the contact or for other reasons. This is an alternative to the preferred embodiment.

As shown in FIGS. 2, 3 and 7, the preferred embodiment also includes a step 18 that defines the back of the central cavity of the jaw end 14, and a step 28 that defines the back of the central cavity of the jaw end 24. Referring to the orientation shown in FIG. 7, the step 18 extends from the right lateral edge of the jaw end 14 partially across the width of the jaw. The step 18 terminates near the shoulder's 15 rightmost edge where the wall 19 is formed. The step 28 extends from the left lateral edge of the jaw end 24 partially across the width of the jaw. The step 28 terminates near the shoulder's 25 leftmost edge where the wall 19 is formed.

The steps 18 and 28 and the walls 19 and 29 accommodate a bulge 51 that is common on virtually all halogen bulbs as shown in phantom in FIGS. 2 and 7. The steps 18 and 28 can seat against the top and bottom of the bulge 51, and the walls 19 and 29 can seat against opposite sides of the bulge 51. However, seating will only occur with a bulb that is of the precise size shown. The steps 18 and 28 and the walls 19 and 29 form a void that accommodates virtually every size of bulge for any contemplated bulb. It is preferred that the distance between the lips 16 and 26 and the steps 18 and 28, respectively, is about one-half inch, although this is not critical. This distance is appropriate for the typical 10 to 50 watt bulb, but it is contemplated that this distance could be changed for a tool designed for different bulbs.

During use, the user of the tool 8 grips the handle ends of the levers 10 and 20 between the thumb and finger (or the fingers and palm) of the hand and squeezes the levers 10 and 20 together. The average person can easily overcome the spreading force of the spring 40 to cause the levers to pivot about the hinge-pin apparatus 30 and force the jaw ends of the levers 10 and 20 apart. The jaws are next placed around the bulb to be removed and the thumb and finger are relaxed slightly so that the handle ends of the levers 10 and 20 are forced apart by the spring 40 until the jaw surfaces seat against the bulb with the bulb in the chamber formed by the facing central jaw cavities. Additionally, the lips 16 and 26 seat against the opposing surfaces of the flat end 52 (shown in phantom in FIG. 2) of the bulb. If there is a slot or groove where the flat end 52 forms a transition with the cylindrical part of the bulb, the lips 16 and 26 seat in that slot or groove.

The user next pulls the tool 8 and the grasped bulb, and the lips 16 and 26 seat against the part of the bulb 50 adjacent the flat end 52 to prevent the bulb 50 from slipping out of the grip of the tool 8. Upon further pulling, the bulb 50 comes out of the fixture, and the user discards it by squeezing the handle ends to spread the jaw ends again. A new bulb is then placed between the jaws, the pins on the bulb are aligned with the terminals in the fixture and the user pushes the combination of the tool 8 and the bulb into the fixture.

If an installing force is required that, due to the angled surfaces of the jaws and the components of force of insertion, tends to cause the jaws to open undesirably, the user can seat his fingers against the ridges 60 and 62 and squeeze the jaws to keep them closed. The ridges 60 and 62 are purposely located between the hinge-pin apparatus 30 and the jaw ends 14 and 24 so that if a user rests his fingers against the ridges and squeezes, the squeezing action will tend to close the jaws. Furthermore, the ridges 60 and 62 prevent the user's fingers from slipping down the inclined surfaces of the outer surface of the jaws when the user places his fingers on the handle side of the ridges. A second set of ridges 64 and 66 is preferably formed closer to the pivot apparatus 30 so that the user naturally places one finger between the pair of ridges on one lever, and the thumb between the pair of ridges on the other lever.

Of course, ridges are not the only protruding shape that will promote finger alignment and prevent slippage. Virtually any other protrusion, such as one or more aligned bumps, will work. And, of course, the closing force can also be applied by fingers positioned between the ridges if there is significant resistance to the removal of the bulb.

While certain preferred embodiments of the present invention have been disclosed in detail, it is to be understood that various modifications may be adopted without departing from the spirit of the invention or scope of the following claims.

1. A bulb grasping tool comprising:
a) a first elongated lever having a jaw end and an opposite handle end;
b) a second elongated lever having a jaw end and an opposite handle end;
c) a pivot pivotably mounting the first and second levers together, said pivot being mounted to the second lever intermediate the jaw and handle ends and to the first lever intermediate the jaw and handle ends;
d) a first jaw at the jaw end of the first lever, the first jaw having
i. a first shoulder near a first lateral edge of the first jaw;
ii. a first lip transverse to the first shoulder and near the jaw end; and
iii. a first central jaw cavity defined by the first shoulder, the first lip, a first jaw floor and a second lateral edge of the first jaw opposite the first lateral edge;
e) a second jaw at the jaw end of the second lever, the second jaw facing the first jaw and having
i. a second shoulder near a first lateral edge of the second jaw, the second shoulder facing the second lateral edge of the first jaw;
ii. a second lip transverse to the second shoulder and near the jaw end, said second lip facing the first lip; and
iii. a second central jaw cavity defined by the second shoulder, the second lip, a second jaw floor and a second lateral edge of the second jaw opposite the first lateral edge, wherein the second central jaw cavity faces the first central jaw cavity forming, in an operable orientation, a chamber therebetween in which a bulb can be placed for grasping.

2. The tool in accordance with claim 1, further comprising a first step on the first jaw, the first step defining a back edge of the first central jaw cavity opposite the first lip, the step extending from substantially the second lateral edge of the first jaw toward the first lateral edge of the first jaw for accommodating the bulb.

3. The tool in accordance with claim 2, further comprising a second step on the second jaw, the second step defining a back edge of the second central jaw cavity opposite the second lip, the step extending from substantially the second lateral edge of the second jaw toward the first lateral edge of the second jaw for accommodating the bulb.

4. The tool in accordance with claim 3, wherein the first step extends only part of a distance from the second lateral edge to the first lateral edge and the second step extends only part of a distance from the second lateral edge to the first lateral edge.

5. The tool in accordance with claim 1, further comprising a first protrusion on an outwardly facing surface of the first lever, and a second protrusion on an outwardly facing surface of the second lever.

6. The tool in accordance with claim 5, wherein said protrusions are between the pivot and the jaw ends of the levers.

7. The tool in accordance with claim 6, further comprising a third protrusion on an outwardly facing surface of the first lever and spaced from the first protrusion and a fourth protrusion on an outwardly facing surface of the second lever and spaced from the second protrusion.

8. The tool in accordance with claim 7, wherein each of said protrusions is a ridge.

9. The tool in accordance with claim 8, further comprising a spring seating at a first spring end against an inwardly facing surface of the first lever between the pivot and the handle end, and said spring seating at a second spring end against an inwardly facing surface of the second lever between the pivot and the handle end.

10. The tool in accordance with claim 1, wherein the first lip is substantially perpendicular to the first shoulder, and wherein the second lip is substantially perpendicular to the second shoulder.

11. The tool in accordance with claim 1, further comprising a third shoulder near the second lateral edge of the first jaw and facing the second shoulder, and a fourth shoulder near the second lateral edge of the second jaw facing the first shoulder.

12. The tool in accordance with claim 1, wherein each lever is substantially identical.
